(19) United States
(12) Patent Application Publication
(10) Pub. No.: US 2025/0348759 A1
(43) Pub. Date: Nov. 13, 2025

(54) CONTENT VERIFICATION SYSTEMS AND METHODS

(71) Applicant: Simbian, Inc., Mountain View, CA (US)

(72) Inventors: Ambuj Kumar, Sunnyvale, CA (US); Alankrit Chona, Redwood City, CA (US); Sumedh Barde, Sammamish, WA (US); John Chong Min Tan, Lor Limau (SG); Vishwas Pai, Bengaluru (IN); Prince Saroj, Bengaluru (IN); Hardik Maheshwari, Bengaluru (IN)

(73) Assignee: Simbian, Inc., Mountain View, CA (US)

(21) Appl. No.: 18/660,804

(22) Filed: May 10, 2024

(51) Int. Cl. G06N 5/022

(52) U.S. Cl. CPC G06N 5/022

(57) ABSTRACT

A system to verify correctness of content is disclosed. The system may include one or more processors and a memory. The processors may obtain, by a content generation LLM, a user prompt via a user interface rendered on a user device, and generate a response to the user prompt responsive to obtaining the user prompt. The content generation LLM may be paired with Retrieval Augmented Generation (RAG) sources. The processors may transmit, by the content generation LLM, the response to a verifier LLM. The processors may parse, by the verifier LLM, the response into structured data, and compare the structured data with data stored in an entity, property, and relationship (ER) database that is paired with the RAG sources and an external database. The processors may determine, by the verifier LLM, correctness of response based on the comparison, and output the correctness of the response on the user interface.

### FIELD

The present disclosure relates to content verification systems and methods, and more particularly to systems and methods for verifying correctness and consistency of AI generated content.

### BACKGROUND

In the field of Artificial Intelligence (AI), the AI generates content that often suffers from “hallucination”. The hallucination occurs when a large language model (LLM) generates false, misleading, or illogical information, which can undermine its reliability, especially in critical applications. In some cases, the AI fabricates content that is not aligned with reality. Typically, the AI hallucinates when the training data is based on incomplete/insufficient, outdated, or low-quality data.

Therefore, there exists a need for a system and method that may verify correctness and consistency of AI generated content.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example system to verify AI generated content in accordance with the present disclosure.

FIG. 2 depicts an example entity and relationship mapping in accordance with the present disclosure.

FIG. 3 depicts example training datasets for a verifier large language model (LLM) in accordance with the present disclosure.

FIG. 4 depicts optimization strategies for the verifier LLM in accordance with the present disclosure.

FIG. 5 depicts a flow diagram of an example method to verify AI generated content in accordance with the present disclosure.

### DETAILED DESCRIPTION

### Overview

The present disclosure describes a system and method to verify/determine correctness and consistency of Artificial Intelligence (AI) generated content. The system may include a layered verification system that comprises a plurality of large language models (LLMs) to verify the content. In some aspects, the plurality of LLMs may include a content generation LLM and a verifier LLM. The content generation LLM may be configured to receive a user prompt, and generate content using static internal knowledge of the content generation LLM. The verifier LLM may obtain the generated content from the content generation LLM, and may verify the content against external dynamic knowledge bases.

In some aspects, the content generation LLM may be paired with Retrieval Augmented Generation (RAG) sources (or Retrieval Augmented Classification (RAC) sources), and may generate the content by using the RAG/RAC sources. In addition, the verifier LLM may be paired with an entity, property, and relationship (ER) database, to verify the content generated by the content generation LLM using entity, property, and relationship. In some aspects, the ER database may include information from the RAG sources and the external dynamic knowledge bases.

In some aspects, the verifier LLM may receive the content generated by the content generation LLM, and parse the generated content to identify entity, property, and relationship from the generated content. The verifier LLM may then compare the identified entity, property, and relationship with the data stored in the ER database, determine a content accuracy (i.e., correctness of the generated content/response) based on the comparison, and output the determined accuracy on a user interface.

In some aspects, the verifier LLM may determine the content accuracy by determining a content provenance (or an origin source from where the content is generated) of the generated content, and output the content provenance on the user interface. The content provenance may indicate the content accuracy. For example, when the verifier LLM determines that the content is generated by using the RAG sources, the verifier LLM may highlight the content using green color (to indicate that the content may be accurate), and when the verifier LLM determines that the content is generated by using the static internal knowledge associated with the content generation LLM, the verifier LLM may highlighted such content in red color (to indicate that the content generator LLM may be hallucinating). The user may view the color coding, and may confirm the data accordingly.

In addition, the verifier LLM may determine the content accuracy by determining an inconsistency in the generated content. In some aspects, the verifier LLM may determine the inconsistency based on the comparison of the identified entity, property, and relationship with the data stored in the ER database.

To ensure that the verifier LLM operates efficiently and effectively in conjunction with the ER database for rapid verification of the generated response, the verifier LLM may adopt several strategies. The strategies include, but are not limited to, pre-training, pre-configuration, and optimization. For example, the verifier LLM may be pre-trained on domain specific knowledge to recognize and understand the entity, property, and relationship. In addition, the verifier LLM may be configured to perform parallel processing, selective verification, and may use other strategies to perform the verification faster.

The present disclosure discloses a system and method that assists a user to determine whether the system is providing accurate results or the system may be hallucinating. By using the ER model and leveraging the layered verification system, the system ensures high fidelity in the responses generated by the system, particularly in the RAG workflows. In addition, since the system is not primarily relying on static knowledge bases, and is verifying the content using dynamic and updated information based on new and domain-specific data, the system ensures reliable response. The verifier LLM may be a smaller and faster LLM as the verifier LLM may be trained to look for entities and relationship and perform the verification, as compared to the content generation LLM.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

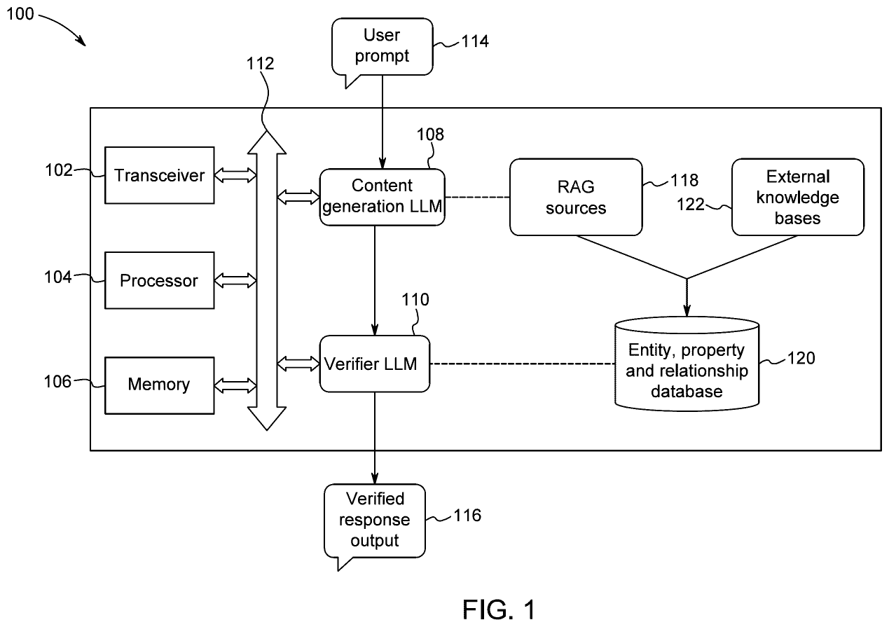

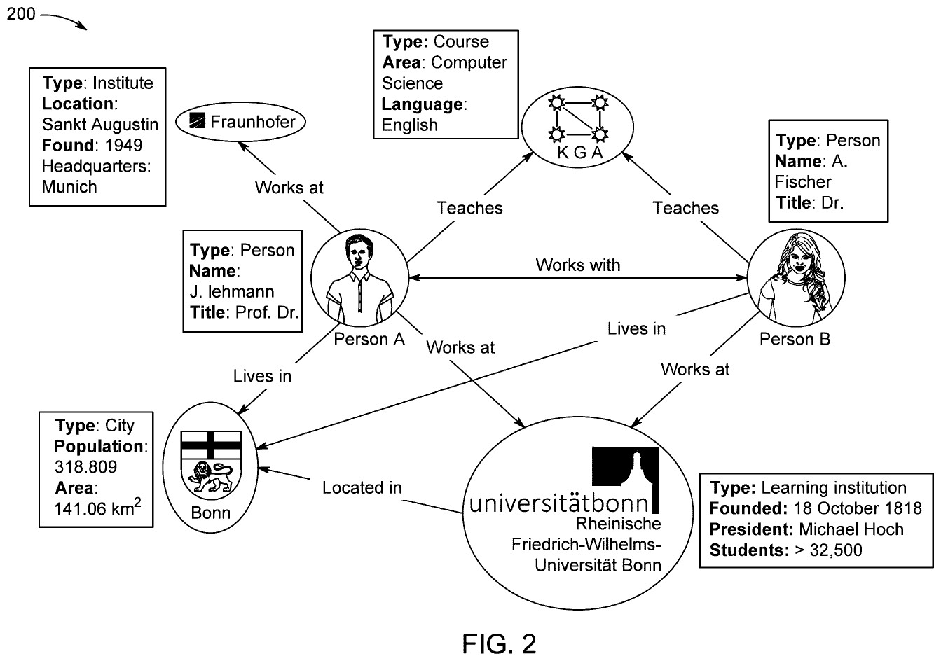

FIG. 1 depicts an example system 100 to verify AI generated content in accordance with the present disclosure. While explaining FIG. 1, references will be made to FIG. 2.

The system 100 may include a plurality of components including, but not limited to, a transceiver 102, a processor 104 (or one or more processors), a memory 106, a content generation large language model (LLM) 108, a verifier LLM 110, which may be communicatively coupled to each other via a data bus 112. In some aspects, the system 100 may include one or more additional LLMs (not shown) to perform system operations described in the present disclosure. Further, the system 100 may be communicatively coupled with a user device (not shown) of a user. In some aspects, the system 100 may be hosted on a server, which may be communicatively coupled with the user device. In other aspects, the system 100 may be installed or hosted on the user device itself.

The transceiver 102 may be configured to transmit/receive information/data to/from external systems and devices, via a network. The network, as described here, illustrates an example communication infrastructure in which the connected devices discussed in various embodiments of this disclosure may communicate. The network may be and/or include the Internet, a private network, public network or other configuration that operates using any one or more known communication protocols such as transmission control protocol/Internet protocol (TCP/IP), Bluetooth®, Bluetooth® Low Energy (BLE), Wi-Fi based on the Institute of Electrical and Electronics Engineers (IEEE) standard 802.11, ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

In some aspects, the transceiver 102 may be configured to obtain a user prompt 114 from a user via a user interface rendered on the user device. The user device may include, for example, a mobile phone, a laptop, a computer, a tablet, a wearable device, or any other device with communication capabilities. The transceiver 102 may be configured to transmit the user prompt 114 to the processor 104 and/or to the content generation LLM 108. In some aspects, the user prompt 114 may be in natural language, which enables the user to easily interact with the system 100 in natural language. In some aspects, the user prompt may be a user query. For example, the user query may be “What is the capital of France?” In alternative aspects, the user query may not be in natural language, and may instead include or be in the form of an image, a document, speech, and/or the like. In further aspects, the transceiver 102 may be configured to output a response 116 to the user prompt 114 (e.g., a response to the query in natural language) on the user device described above.

The processor 104 may utilize the memory 106 to store programs in code and/or to store data for performing aspects in accordance with the disclosure. The memory 106 may be a non-transitory computer-readable storage medium or memory storing a program code that enables the processor 104 to perform operations in accordance with the present disclosure. The memory 106 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

The content generation LLM 108 and the verifier LLM 110 may be configured to receive and process natural language (NL) content, and generate an NL based response, which may be rendered on the user interface responsive to receiving the user prompt 114. In some aspects, the content generation LLM 108 and the verifier LLM 110 may be machine learning models that may comprehend and generate human language text. The content generation LLM 108 and the verifier LLM 110 may be implemented by the processor 104. In some aspects, the content generation LLM 108 and the verifier LLM 110 may be stored in the memory 106. In other aspects, the content generation LLM 108 and the verifier LLM may be stored outside the memory 106.

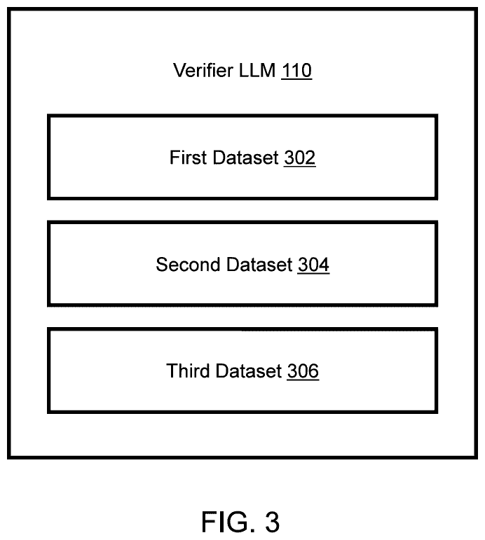

The content generation LLM 108 may be configured to perform the task (or generate content) associated with the user prompt 114, and the verifier LLM 110 may be configured to verify the content generated by the content generation LLM 108. In some aspects, the content generation LLM 108 may be pre-trained on a first training dataset and the verifier LLM 110 may be pre-trained on a second training dataset. The first training dataset may be different from the second training dataset. In some aspects, the content generation LLM 108 may include a static internal knowledge. Stated another way, the first training dataset is a static dataset (and hence may not be updated frequently, or may not be dynamic). The details associated with the second training dataset are described later in the description below in conjunction with FIG. 3.

In some aspects, the processor 104 may obtain the user prompt 114 from the transceiver 102. Responsive to obtaining the user prompt 114, the processor 104 may generate, by the content generation LLM 108, a response to the user prompt 114. In some aspects, the content generation LLM 108 may be configured to parse the user prompt 114 into a structured data (e.g., a first structured data), and process the structured data to generate the response to the user prompt 114. In some aspects, the content generation LLM 108 may use the first training dataset (e.g., static internal knowledge) to generate the response to the user prompt.

In further aspects, the content generation LLM 108 may be paired with one or more Retrieval Augmented Generation (RAG) sources 118, as shown in FIG. 1. In some aspects, the content generation LLM 108 may be communicatively coupled with the RAG sources via the network described above. The RAG sources 118 may be any data source including, but not limited to, an application programming interface (API), databases, document repositories, and/or the like. The data in the RAG sources 118 may be in any format such as files, database records, or long-form text. For example, the RAG sources 118 may include internal documents of a company/firm (including internal organization structure or legal documents) that may be paired with the content generation LLM 108 to generate the response to the user prompt 114. The content generation LLM 108 may be configured to generate the response based on the RAG sources 118 and the internal knowledge associated with the content generation LLM 108. For example, the content generation LLM 108 may be configured to generate the response as “Paris is the capital of France”, in response to the user query “What is the capital of France?”

The processor 104 may be further configured to transmit the response generated by the content generation LLM 108 to the verifier LLM 110, determine a response accuracy/correctness via the verifier LLM 110, and output the response accuracy to the user interface in the response 116, as described below. Stated another way, the content generation LLM 108 may transmit the generated response to the verifier LLM 110.

The verifier LLM 110 may obtain the generated response from the content generation LLM 108. Responsive to obtaining the generated response, the verifier LLM 110 may parse the generated response into a structured data (e.g., a second structured data). In some aspects, the verifier LLM 110 may parse the generated response to identify entity, property, and relationship from the generated response. In an example, the user query may include “Could you summarize the discussion with company's Vice President today from the company call recording database?” In such cases, the content generation LLM 108 may generate the summary. The verifier LLM 110 may then obtain the summary, parse the summary to identify the entities (e.g., person name, person designation in the company, etc.) and the statements made by the respective entities.

In some aspects, the verifier LLM 110 may be paired with an entity, property, and relationship (ER) database 120, to verify the content generated by the content generation LLM 108 using entity, property, and relationship. The ER database 120 may be a model that illustrates how entities such as people, objects, concepts etc., relate to each other within a system, and attributes associated with the entities/relationship. FIG. 2 depicts an example entity and relationship mapping 200 in accordance with the present disclosure. The mapping 200 may include names of persons, how they are connected with each other, and/or the like. For example, as shown in FIG. 2, both the person “A” and the person “B” work at a learning institute, which indicates that they may be colleagues or students at the learning institute.

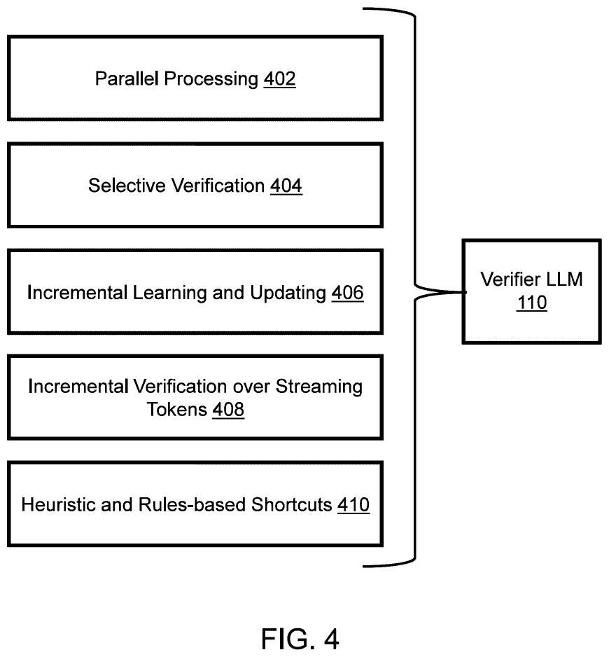

To ensure that the verifier LLM 110 operates efficiently and effectively in conjunction with the ER database 120 for rapid verification of the generated response, the verifier LLM 110 may be adopted with several strategies. The strategies include, but are not limited to, pre-training and optimization. The details of pre-training the verifier LLM 110 may be understood in conjunction with FIG. 3, and the details of optimization may be understood in conjunction with FIG. 4, described later in the description below.

In some aspects, the ER database 120 may be communicatively coupled to the RAG sources 118 and one or more external dynamic knowledge bases 122. The external dynamic knowledge bases 122 may a real-time or dynamic database and may be an up to date database. The external dynamic knowledge bases 122 may include broad information about factual information/things in the world. In some aspects, the data from the RAG sources 118 and the external dynamic knowledge bases 122 may be processed (e.g., via a data ingestion process) and stored in the ER database 120. Stated another way, the ER database 120 may include information from the external dynamic knowledge bases 122 and the RAG sources 118. In some aspects, the ER database 120 may include metadata associated with the RAG sources 118 and/or the external dynamic knowledge bases 122. The metadata may include, but is not limited to, document author, the date on which the document was last updated, and/or the like.

The verifier LLM 110 may use/query the ER database 120 to determine the content/response accuracy. In some aspects, to determine the response accuracy, the verifier LLM 110 may compare the second structured data with the data stored in the ER database 120. Stated another way, the verifier LLM 110 may compare the identified entity, property, and relationship from the generated response with the entity, property, and relationship stored in the ER database 120. Based on the comparison, the verifier LLM 110 may determine the response accuracy, and output the response accuracy on the user interface.

To determine the response accuracy, the verifier LLM 110 may further identify a content provenance of the generated response. Stated another way, the verifier LLM 110 may determine a source of origin for the generated response. For example, the verifier LLM 110 may determine whether the source of origin is the RAG sources 118, the external dynamic knowledge bases 122, the static internal knowledge (associated with the content generation LLM 108), or the user prompt 114. Stated another way, the verifier LLM 110 may identify the content provenance from at least one of the RAG sources 118, the external dynamic knowledge bases 122, the static internal knowledge, or the user prompt 114. In some aspects, the verifier LLM 110 may identify the content provenance based on the comparison of the second structured data with the data stored in the ER database 120.

Responsive to identifying the content provenance, the verifier LLM 110 may determine the response accuracy/correctness based on the content provenance. For example, when the verifier LLM 110 compares the second structured data with the data stored in the ER database 120, the verifier LLM 110 may identify a match of the second structured data in the ER database 120. When the verifier LLM 110 identifies a match, the verifier LLM 110 may fetch the corresponding/associated metadata from the ER database 120 and determine whether the match is found in the RAG sources 118 or the external dynamic knowledge bases 122. In some aspects, the verifier LLM 110 may determine the content provenance as the RAG sources 118 or the external dynamic knowledge bases 122 when a match is found. When the match is not found, the verifier LLM 110 may determine that the source of origin for the generated response may be the static internal knowledge associated with the content generation LLM 108. In some aspects, the verifier LLM 110 may determine that the content/response accuracy may be low when the response is generated using the static internal knowledge associated with the content generation LLM 108 (as the content generation LLM 108 may be hallucinating). Similarly, the verifier LLM 110 may determine that the content accuracy may be relatively high when the response is generated using the RAG sources 118 (or the content source is found in the external dynamic knowledge bases 122).

For example, when the user query is “Could you summarize the discussion with company's Vice president today from the company call recording database?”, the verifier LLM 110 may identify the entity, property, and relationship from the response generated by the content generation LLM 108, and compare the identified entity, property, and relationship with the data stored in the ER database 120. Based on the comparison, the verifier LLM 110 may determine that the content generation LLM 108 may not have generated the summary by using the RAG sources 118 and may have instead fabricated the summary by using the static internal knowledge associated with the content generation LLM 108. In such cases, the verifier LLM 110 may determine that the content accuracy may be low.

In this manner, the verifier LLM 110 may determine whether the response is generated by using the internal knowledge associated with the content generation LLM 108, or by using external verified and accurate knowledge (e.g., the RAG sources 118 and the external dynamic knowledge bases 122), and determine the content accuracy accordingly. Stated another way, the verifier LLM 110 may segregate or separate static internal knowledge from the external sources, determine whether the response is generated by using the static internal knowledge or the external sources, and determine the content accuracy based on the identified content source.

In addition, to determine the response/content accuracy, the verifier LLM 110 may determine inconsistency in the second structured data and the data stored in the ER database 120. In some aspects, the verifier LLM 110 may determine the inconsistency based on the comparison (described above) and determine the accuracy based on the inconsistency. For example, when the content generated by the content generation LLM does not match with the data stored in the ER database 120, the verifier LLM 110 may determine the inconsistency. Since the ER database 120 is using the information from the external dynamic knowledge bases 122 as well, which includes “evolving” or “dynamic” nature of knowledge (including specification of different domains), the verifier LLM 110 may reliably determine the authenticity and accuracy of the generated response/content. Stated another way, the verifier LLM 110 may ensure that the generated content/response is verified against the external dynamic knowledge bases 122 that are up to date and accurate, as opposed to the “static” data used by the content generation LLM 108 to generate the content/response.

For example, the verifier LLM 110 may identify that the response “Paris is the capital of France” generated by the content generation LLM 108 may be correct based on the verification against the external sources (e.g., the external dynamic knowledge bases 122). In addition to verification of facts, the verifier LLM 110 may determine the inconsistency based on logical reasoning. For example, if the content generation LLM 108 generates the response that indicates that the person “A” and the person “B” live in different cities, the verifier LLM 110 may verify the statement through logical reasoning based on the data stored in the ER database 120. For instance, the verifier LLM 110 may find that the person “A” works with the person “B”, and the person “A” works in city “C”, thus, the verifier LLM 110 may determine/infer that the person “A” and the person “B” live in the same city “C”. In this case, the verifier LLM 110 may determine that the response generated by the content generation LLM 108 may not be accurate. In some aspects, the verifier LLM 110 may determine the level of inconsistency based on such logical reasoning. For example, the verifier LLM 110 may verify the above statements through different routes/methods, and may indicate a high level of inconsistency when the verifier LLM 110 infers that the person “A” and the person “B” are from the same city via different routes in the ER database 120.

In some aspects, the verifier LLM 110 may output the response accuracy on the user interface. In some aspects, the verifier LLM 110 may map the content provenance to a predefined color coding and output the mapped content provenance in the response 116 to indicate the content accuracy. Stated another way, outputting the accuracy to the user interface may include outputting the mapped content provenance on the user interface. For example, the verifier LLM 110 may indicate the content generated by using the RAG sources 118 in green color, indicate the content generated by using the static internal knowledge associated with the content generation LLM 108 in red color, and indicate the data highlighted in red color as the data that may not be inaccurate. The user may then confirm the data generated in the red color.

In further aspects, the verifier LLM 110 may perform the mapping described above based on user's preferences. For example, the verifier LLM 110 may indicate the content generated by using the external dynamic knowledge bases 122 in red color as the user may not trust the external dynamic knowledge bases 122, and the content generated by using the internal document/RAG sources 118 in green color as the user may trust the internal document (e.g., user or company document).

In this manner, the verifier LLM 110 may indicate/output the level of hallucination (e.g., the level of inconsistency) during the output generation, inputs/sources used to generate the response, and/or the like.

In additional aspects, the verifier LLM 110 may determine an aggregated response accuracy. For example, the verifier LLM 110 may determine the amount or portion of the generated response that is generated by using the static internal knowledge, the amount or portion that is generated by using the RAG sources 118 (and so on), and determine an overall/aggregated response accuracy. The verifier LLM 110 may further output the aggregated accuracy on the user interface. In further aspects, the verifier LLM 110 may be configured to determine one or more characteristics (e.g., information associated with entity, property, and relationship) associated with the generated response, and determine the accuracy based on the characteristics. For example, the verifier LLM 110 may determine person's title and/or the background/expertise of the person from whom the fact/response is generated, and may determine the accuracy based on such information. In some aspects, each characteristic may be associated with a weight, and the verifier LLM 110 may determine the aggregated accuracy based on the weights. As an example, a VP of a company may be given a higher weight than an analyst, and hence when the response is generated based on a speech given by the VP, the verifier LLM 110 may determine the response to be more accurate (as compared to when the response is generated based on information provided by the analyst).

FIG. 3 depicts example training datasets for the verifier LLM 110 in accordance with the present disclosure. The verifier LLM 110 may include logical inference tools that may enable the verifier LLM 110 to perform functions described in the present disclosure. In some aspects, the verifier LLM 110 may be pre-trained on a first dataset 302, a second dataset 304, and a third dataset 306. The first dataset 302 may include domain-specific literature, factual data/knowledge, and historical data associated with entities, properties, and their relationships. The first dataset 302 may be used to embed deep knowledge about a wide range of entities, properties, and their relationships. Since the verifier LLM 110 may be trained on domain specific knowledge, the verifier LLM 110 may accurately understand and identify the entity, property, and relationship from natural language.

The second dataset 304 may include logical reasoning datasets and consistency checking datasets to implement logical reasoning and detect inconsistency between the second structured data and the data stored in the ER database 120, and to understand the context. In some aspects, the second dataset 304 may include puzzle-solving, inference-making tasks, and consistency-checking exercises/datasets.

The third dataset 306 may include datasets to recognize and understand the key entities, properties, and relationships from the response generated by the content generation LLM 108. Stated another way, the verifier LLM 110 may be trained to recognize and understand various entities, their properties, and the relationships between them. This involves not just identification, but also comprehending the significance and implications of these relationships. Utilizing the pre-trained knowledge and logical reasoning capabilities, the verifier LLM 110 assesses the coherence of the content, flags inconsistencies, and validates factual correctness.

FIG. 4 depicts optimization strategies for the verifier LLM 110 in accordance with the present disclosure. In some aspects, the verifier LLM 110 may use various optimization strategies to increase the speed to determine content accuracy. In an exemplary aspect, the verifier LLM 110 may be configured to perform parallel processing, as shown by a block 402. In the parallel processing, the verifier LLM 110 may be configured to perform the comparison on different portions of the second structured data simultaneously. Stated another way, the verifier LLM 110 may be configured to simultaneously verify different components/portions of the generated response against the ER database 120 by using parallel processing strategy. The parallel processing strategy may significantly reduce total verification time of the response.

In further aspects, the verifier LLM 110 may be configured to perform selective verification, as shown by a block 404. Specifically, the verifier LLM 110 may select a subset portion of the second structured data based on a predetermined criteria, compare the subset portion with the data stored in the ER database 120, and determine the accuracy based on the comparison. In some aspects, the verifier LLM 110 may select the content or portion from the second structured data that is critical, ambiguous, or prone to inaccuracies for performing the selective verification. This may be useful as not all parts of the generated response may require an in-depth verification check, thereby optimizing the overall process.

In further aspects, the verifier LLM 110 may be configured to perform incremental learning and updating, as shown by a block 406. Specifically, the verifier LLM 110 may be configured to receive user feedback responsive to outputting the accuracy, and update the ER database 120 and/or the verifier LLM itself based on the user feedback. The verifier LLM 110 may continuously update the ER database 120 (and/or the verifier LLM itself) with new information, corrections, and feedback loops from verification outcomes. Use of incremental learning techniques may allow the verifier LLM 110 to adapt without requiring full retraining, thereby maintaining its speed and efficiency.

In further aspects, the verifier LLM 110 may be configured to perform incremental verification over streaming tokens, as shown by a block 408. Specifically, the verifier LLM 110 may be configured to perform the parsing of the generated response at every predefined buffering length. Stated another way, the verifier LLM 110 may run the checks at every fixed buffering length, which enables the verifier LLM 110 to speed up the verification process and generate the output faster.

In further aspects, the verifier LLM 110 may be configured to apply heuristic and rules-based shortcuts, as shown by a block 410. The verifier LLM 110 may implement the heuristic and rules-based shortcuts for common verification scenarios. For example, if a certain type of entity relationship has a known pattern or a high likelihood of being accurate, the verifier LLM 110 may use these shortcuts to speed up the verification process.

In further aspects, the ER database 120 may be pre-configured to effectively operate with the verifier LLM 110. In some aspects, the ER database 120 may be designed with a structured schema that categorizes entities, properties, and relationships in a way that mirrors the knowledge representation within the verifier LLM 110. This may include categorizations such as people, places, events, and their interconnected properties and relationships. In addition, the ER database 120 may implement indexing and hashing mechanisms within the ER database 120 to enable quick lookups. For example, the entity names can be indexed, and the relationships can be hashed for rapid retrieval during the verification process.

In further aspects, the ER database 120 may be pre-configured to identify and pre-load frequently accessed entities, properties, and relationships into a fast-access cache layer. This reduces lookup times for common queries and verification checks. In addition, document metadata for the RAG sources 118 may serve as properties of the entities extracted from those. By using such strategies (e.g., pre-configuration, optimization strategies), the verification process may be completed rapidly, ensuring that the final content is both accurate and generated within an acceptable timeframe.

In addition to the aspects described above, the system 100 may be configured to track the content provenance and store the tracking information. For example, the system 100 may track modifications to a content and store information associated with such modifications to track the content provenance. In further aspects, the verifier LLM 110 may create a cryptographic signature (to verify the content provenance) responsive to determining the accuracy. In some aspects, the verifier LLM 110 may create the cryptographic signature that includes one or more of a cryptographic hash of the generated content, attributes associated with content generation LLM 108 identification, attributes associated with content generation LLM environment, all inputs of the verifier LLM 110 (or inputs for checking hallucination), all outputs of the verifier LLM 110 (or results of hallucination check), date or time, and/or the like. In some aspects, the cryptographic signature may include content generation LLM's complete prompt including system prompt and the user prompt 114.

In some aspects, the attributes associated with the content generation LLM 108 identification may include model's author (e.g. developer, company, etc.), a unique identification number, the model task, the number of parameters, and a time stamp of when the models were uploaded to a server. The attributes associated with content generation LLM 108 environment may include whether the content generation LLM 108 was using Confidential GPU, attestation report, and/or the like.

In some aspects, the cryptographic signature may be calculated by using a key of the entity performing the content generation. The user may find a public key of the entity from an endpoint published by the LLM provider, or the user may find the public key from a trusted third-party database. In some aspects, the cryptographic signature may be stored in a database that is accessible through web API. The user may take a target image/content and do a similarity search on contents stored in the database and if there is a match, then the cryptographic proof may be produced.

The content provenance tracking provides various advantages. For example, the user may determine from where the system 100 is pulling the content from. In addition, the user may track the content provenance (by using the cryptographic signature) to determine if the user can use the content without any copyright infringement concerns. This may be helpful as some data sources offer indemnification, but some may not offer the indemnification. The content provenance tracking may facilitate the user to determine if the user can use the content without any copyright infringement concerns. In addition, the content provenance tracking may facilitate the user to determine if the content is generated by using the user prompt 114 or the system prompt.

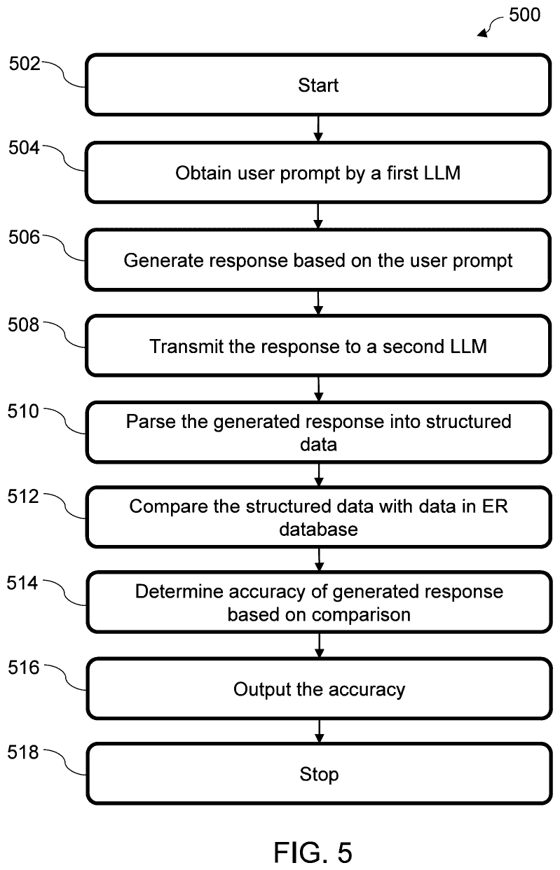

FIG. 5 depicts a flow diagram of an example method 500 to verify AI generated content in accordance with the present disclosure. FIG. 5 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 500 starts at step 502. The method 500 may be implemented by the processor 104, via the content generation LLM 108 and the verifier LLM 110. At step 504, the method 500 may include obtaining, by the content generation LLM 108 (or a first LLM), the user prompt 114 via the user interface rendered on the user device. At step 506, the method 500 may include generating, by the content generation LLM 108, the response to the user prompt 114, responsive to obtaining the user prompt 114. The content generation LLM 108 may be configured to generate the response based on the RAG sources 118 and a static internal knowledge associated with the content generation LLM 108.

At step 508, the method 500 may include transmitting, by the content generation LLM 108, the response to the verifier LLM 110 (e.g., a second LLM). At step 510, the method 500 may include parsing, by the verifier LLM 110, the response into structured data. At step 512, the method 500 may include comparing, by the verifier LLM 110, the structured data with the data stored in the ER database 120. As mentioned above, the ER database 120 may include information from the RAG sources 118 and the external dynamic knowledge bases 122. At step 514, the method 500 may include determining, by the verifier LLM 110, a response accuracy based on the comparison. At step 516, the method 500 may include outputting, by the verifier LLM 110, the response accuracy on the user interface.

At step 518, the method 500 may stop.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A system comprising:
one or more processors; and
a memory storing instructions that, when executed by the one or more processors, causes the system to:
obtain, by a content generation large language model (LLM), a user prompt via a user interface rendered on a user device;
generate, by the content generation LLM, a response to the user prompt responsive to obtaining the user prompt, wherein the content generation LLM is paired with one or more Retrieval Augmented Generation (RAG) sources, wherein the content generation LLM is configured to generate the response based on the one or more RAG sources and a static internal knowledge associated with the content generation LLM;
transmit, by the content generation LLM, the response to a verifier LLM;
parse, by the verifier LLM, the response into structured data;
compare, by the verifier LLM, the structured data with data stored in an entity, property, and relationship (ER) database, wherein the ER database is paired with the verifier LLM, and wherein the ER database comprises information from one or more external dynamic knowledge bases and the one or more RAG sources;
determine, by the verifier LLM, correctness of the response based on the comparison; and
output, by the verifier LLM, the correctness of the response on the user interface.

2. The system of claim 1 further comprising a transceiver configured to receive the user prompt from a user via the user interface.

3. The system of claim 1, wherein the ER database comprises metadata associated with the one or more RAG sources.

4. The system of claim 1, wherein the memory further stores instructions that, when executed by the one or more processors, causes the system to:
identify a content provenance of the response based on the comparison; and
determine the correctness based on the identification of the content provenance.

5. The system of claim 4, wherein the identification of the content provenance comprises identifying the content provenance from at least one of: the one or more RAG sources, the static internal knowledge, the one or more external dynamic knowledge bases, or the user prompt.

6. The system of claim 4, wherein the memory further stores instructions that, when executed by the one or more processors, causes the system to:
map the content provenance to a predefined color coding; and
output the correctness of the response based on the mapping, wherein outputting the correctness comprises outputting the mapping of the content provenance to indicate the correctness of the response.

7. The system of claim 1, wherein the memory further stores instructions that, when executed by the one or more processors, causes the system to:
determine an inconsistency in the structured data and the data stored in the ER database based on the comparison; and
determine the correctness based on the inconsistency.

8. The system of claim 1, wherein the verifier LLM is pre-trained on a training dataset.

9. The system of claim 8, wherein the training dataset comprises domain-specific literature, factual data, and historical data associated with entities, properties, and their relationships.

10. The system of claim 8, wherein the training dataset comprises logical reasoning datasets and consistency checking datasets to implement logical reasoning and detect inconsistency between the structured data and the data stored in the ER database.

11. The system of claim 8, wherein the training dataset comprises datasets to recognize and understand entities, properties, and relationships from the response.

12. The system of claim 1, wherein the memory further stores instructions that, when executed by the one or more processors, causes the system to perform the comparison on different portions of the structured data simultaneously.

13. The system of claim 1, wherein the memory further stores instructions that, when executed by the one or more processors, causes the system to perform parsing at every predefined buffering length.

14. The system of claim 1, wherein the memory further stores instructions that, when executed by the one or more processors, causes the system to:
select a subset portion of the structured data based on a predetermined criteria;
compare the subset portion with data stored in the ER database; and
determine the correctness responsive to the comparison.

15. The system of claim 1, wherein the memory further stores instructions that, when executed by the one or more processors, causes the system to:
obtain a user feedback responsive to outputting the correctness; and
update the ER database based on the user feedback.

16. The system of claim 4, wherein the memory further stores instructions that, when executed by the one or more processors, causes the system to create a cryptographic signature to verify the content provenance.

17. The system of claim 16, wherein the cryptographic signature comprises one or more of: a cryptographic hash of the response, attributes associated with an identification of the content generation LLM, attributes associated with an environment of the content generation LLM, all inputs of the verifier LLM, all output of the verifier LLM, and date or time.

18. A method comprising:
obtaining, by a content generation large language model (LLM), a user prompt via a user interface rendered on a user device;
generating, by the content generation LLM, a response to the user prompt responsive to obtaining the user prompt, wherein the content generation LLM is paired with one or more Retrieval Augmented Generation (RAG) sources, wherein the content generation LLM is configured to generate the response based on the one or more RAG sources and a static internal knowledge associated with the content generation LLM;
transmitting, by the content generation LLM, the response to a verifier LLM;
parsing, by the verifier LLM, the response into structured data;
comparing, by the verifier LLM, the structured data with data stored in an entity, property, and relationship (ER) database, wherein the ER database is paired with the verifier LLM, and wherein the ER database comprises information from one or more external dynamic knowledge bases and the one or more RAG sources;
determining, by the verifier LLM, correctness of the response based on the comparison; and
outputting, by the verifier LLM, the correctness of the response on the user interface.

19. The method of claim 18 further comprising:
identifying content provenance of the response based on the comparison; and
determining the correctness based on the identification of the content provenance.

20. A non-transitory computer-readable storage medium having instructions stored thereupon which, when executed by a processor, cause the processor to:
obtain, by a content generation large language model (LLM), a user prompt via a user interface rendered on a user device;
generate, by the content generation LLM, a response to the user prompt responsive to obtaining the user prompt, wherein the content generation LLM is paired with one or more Retrieval Augmented Generation (RAG) sources, wherein the content generation LLM is configured to generate the response based on the one or more RAG sources and a static internal knowledge associated with the content generation LLM;
transmit, by the content generation LLM, the response to a verifier LLM;
parse, by the verifier LLM, the response into structured data;
compare, by the verifier LLM, the structured data with data stored in an entity, property, and relationship (ER) database, wherein the ER database is paired with the verifier LLM, and wherein the ER database comprises information from one or more external dynamic knowledge bases and the one or more RAG sources;
determine, by the verifier LLM, correctness of the response based on the comparison; and
output, by the verifier LLM, the correctness of the response on the user interface.
